(19) United States
(12) Patent Application Publication
(10) Pub. No.: US 2023/0011633 A1
(43) Pub. Date: Jan. 12, 2023

(54) SYSTEMS AND METHODS FOR SCALABLE BIOMETRIC AUTHENTICATION

(71) Applicant: JPMORGAN CHASE BANK, N.A., New York, NY (US)

(72) Inventors: Derek WALDRON, New York, NY (US); Akrati JOHARI, New York, NY (US); Michelle Helen LEE, New York, NY (US); Denis KOCHEDYKOV, Brooklyn, NY (US); Oleg RASSKAZOV, New York, NY (US)

(21) Appl. No.: 17/811,244

(22) Filed: Jul. 7, 2022

Related U.S. Application Data
(60) Provisional application No. 63/219,749, filed on Jul. 8, 2021.
(60) Provisional application No. 63/220,914, filed on Jul. 12, 2021.

(51) Int. Cl. G06Q 20/38; H04L 9/08

(52) U.S. Cl. CPC G06Q 20/3821; H04L 9/0866

(57) ABSTRACT

Systems and methods for scalable biometric authentication are disclosed. In one embodiment, a method for scalable biometric authentication may include: (1) receiving, by a biometric authentication computer program executed by a computer processor, a transaction request for a transaction comprising a received biometric; (2) identifying, by the biometric authentication computer program, a subset of likely customers from a set of customers for the transaction; (3) retrieving, by the biometric authentication computer program, stored biometrics for the subset of customers; (4) identifying, by the biometric authentication computer program, one of the stored biometrics for the subset of customers that matches the received biometric; and (5) retrieving, by the biometric authentication computer program, a stored payment method for the identified stored biometric.

### RELATED APPLICATIONS

This application claims priority to, and the benefit of, U.S. Provisional patent application Ser. No. 63/219,749, filed Jul. 8, 2021 and U.S. Provisional patent application Ser. No. 63/220,914, filed Jul. 12, 2021, the disclosure of each of which is hereby incorporated, by reference, in its entirety.

### BACKGROUND OF THE INVENTION

### 1. Field of the Invention

Embodiments generally relate to systems and methods for scalable biometric authentication.

### 2. Description of the Related Art

Biometric authentication has become very popular in a variety of applications, including authentication to smartphone applications. In existing applications, to authenticate a user, the operating system or application only needs to compare a received biometric to a single or small number of biometric profiles stored in a database.

### SUMMARY OF THE INVENTION

Systems and methods for scalable biometric authentication are disclosed. In one embodiment, a method for scalable biometric authentication may include: (1) receiving, by a biometric authentication computer program executed by a computer processor, a transaction request for a transaction comprising a received biometric; (2) identifying, by the biometric authentication computer program, a subset of likely customers from a set of customers for the transaction; (3) retrieving, by the biometric authentication computer program, stored biometrics for the subset of customers; (4) identifying, by the biometric authentication computer program, one of the stored biometrics for the subset of customers that matches the received biometric; and (5) retrieving, by the biometric authentication computer program, a stored payment method for the identified stored biometric.

In one embodiment, the received biometric and the stored biometrics may include a palm biometric, a fingerprint biometric, a facial biometric, a voice biometric, and/or an eye biometric.

In one embodiment, the subset of customers may be identified based on a customer location and a merchant location, the customer's purchase history, etc.

In one embodiment, the method may also include authorizing, by the biometric authentication computer program, the transaction.

According to another embodiment, a method for scalable biometric authentication may include: (1) retrieving, by a biometric authentication computer program executed by a computer processor, a plurality of stored biometrics from a biometric database; (2) generating, by the biometric authentication computer program, an index for each the plurality of stored biometrics; (3) receiving, by the biometric authentication computer program, a transaction request comprising a received biometric; (4) generating, by the biometric authentication computer program, an index for the received biometric; (5) retrieving, by the biometric authentication computer program, a subset of the plurality of stored biometrics based on the index of the received biometric and the indices of the plurality of stored biometrics; (6) identifying, by the biometric authentication computer program, one of the plurality of stored biometrics in the subset that matches the received biometric; and (7) retrieving, by the biometric authentication computer program, a stored payment method for the identified stored biometric.

In one embodiment, the received biometric and the stored biometrics may include a palm biometric, a fingerprint biometric, a facial biometric, a voice biometric, and/or an eye biometric.

In one embodiment, the index for each of the plurality of stored biometrics may be generated by auto-encoding the stored biometric, and the index of the received biometric may be generated by auto-encoding the stored biometric.

In one embodiment, the index for each of the plurality of stored biometrics may include a numeric multidimensional vector, and the index of the received biometric may include a numeric multidimensional vector.

In one embodiment, the index for each the plurality of stored biometrics may include a score for a feature in each biometric, and the index of the received biometric may include a score for the feature in the received biometric.

In one embodiment, the index for each of the plurality of stored biometrics may include a hash of the stored biometric, and the index of the received biometric may include a hash of the received biometric.

According to another embodiment, a method for biometric registration may include: (1) receiving, by a biometric authentication computer program executed by a computer processor and from a biometric reading device, a biometric from a user; (2) hashing, by the biometric authentication computer program and using a hash function, the biometric; (3) comparing, by the biometric authentication computer program, the hashed biometric to a plurality of stored biometric hashes for registered biometrics in a biometric hash database, wherein the plurality of stored biometric hashes are generated using the hash function; (4) determining, by the biometric authentication computer program, that the hashed biometric does not match any of the stored biometric hashes; and (5) storing, by the biometric authentication computer program, the biometric in a biometric database.

In one embodiment, the biometric may include a palm biometric, a fingerprint biometric, a facial biometric, a voice biometric, and/or an eye biometric.

In one embodiment, the method may also include encrypting, by the biometric authentication computer program, the biometric before storing the biometric in the biometric database.

According to another embodiment, a non-transitory computer readable storage medium, may include instructions stored thereon, which when read and executed by one or more computer processors, cause the one or more computer processors to perform steps comprising: receiving a transaction request for a transaction comprising a received biometric, identifying a subset of likely customers from a set of customers for the transaction, retrieving stored biometrics for the subset of customers, identifying one of the stored biometrics for the subset of customers that matches the received biometric, and retrieving a stored payment method for the identified stored biometric.

According to another embodiment, a non-transitory computer readable storage medium, may include instructions stored thereon, which when read and executed by one or more computer processors, cause the one or more computer processors to perform steps comprising: retrieving a plurality of stored biometrics from a biometric generating an index for each the plurality of stored biometrics, receiving a transaction request comprising a received biometric, generating an index for the received biometric, retrieving a subset of the plurality of stored biometrics based on the index of the received biometric and the indices of the plurality of stored biometrics, identifying one of the plurality of stored biometrics in the subset that matches the received biometric, and retrieving a stored payment method for the identified stored biometric.

According to another embodiment, a non-transitory computer readable storage medium, may include instructions stored thereon, which when read and executed by one or more computer processors, cause the one or more computer processors to perform steps comprising: receiving from a biometric reading device, a biometric from a user, hashing, using a hash function, the biometric, comparing the hashed biometric to a plurality of stored biometric hashes for registered biometrics in a biometric hash database, wherein the plurality of stored biometric hashes are generated using the hash function, determining that the hashed biometric does not match any of the stored biometric hashes, and storing the biometric in a biometric database.

According to another embodiment, a system may include an electronic device executing a biometric authentication computer program, a biometric reading device, and a database comprising a plurality of biometrics, wherein the biometric authentication computer program receives a transaction request for a transaction comprising a received biometric from a biometric reading device, identifies a subset of likely customers from a set of customers for the transaction, retrieves stored biometrics for the subset of customers from the database, identifies one of the stored biometrics for the subset of customers that matches the received biometric, and retrieves a stored payment method for the identified stored biometric.

According to another embodiment, a system may include an electronic device executing a biometric authentication computer program, a biometric reading device, and a biometric database comprising a plurality of biometrics, wherein the biometric authentication computer program retrieves a plurality of stored biometrics from the biometric database, generates an index for each the plurality of stored biometrics, receives a transaction request comprising a received biometric from the biometric reading device, generates an index for the received biometric, retrieves a subset of the plurality of stored biometrics based on the index of the received biometric and the indices of the plurality of stored biometric, identifies one of the plurality of stored biometrics in the subset that matches the received biometric, and retrieves a stored payment method for the identified stored biometric.

According to another embodiment, a system may include an electronic device executing a biometric authentication computer program, a biometric reading device, and a biometric database comprising a plurality of biometrics, wherein the biometric authentication computer program receives a biometric from a user from the biometric reading device, hashes, using a hash function, the biometric, compares the hashed biometric to a plurality of stored biometric hashes for registered biometrics in a biometric hash database, wherein the plurality of stored biometric hashes are generated using the hash function, determines that the hashed biometric does not match any of the stored biometric hashes, and stores the biometric in a biometric database.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for scalable biometric authentication according to embodiments.

FIG. 2 depicts a method for scalable biometric authentication according to embodiments.

FIG. 3 depicts a method for scalable biometric authentication is disclosed according to another embodiment.

FIG. 4 depicts a method for biometric registration is disclosed according to one embodiment.

FIG. 5 depicts an exemplary computing system for implementing aspects of the present disclosure.

### DETAILED DESCRIPTION OF PREFERRED EMBODIMENTS

Systems and methods for scalable biometric authentication (i.e., quickly identifying and/or authenticating a user using a large database of profiles based only on the user's provided biometric data) are disclosed. In one embodiment, the biometric may be a palm (e.g., palm veins), a fingerprint, a face, an iris, etc. The biometric may be received with or without contact.

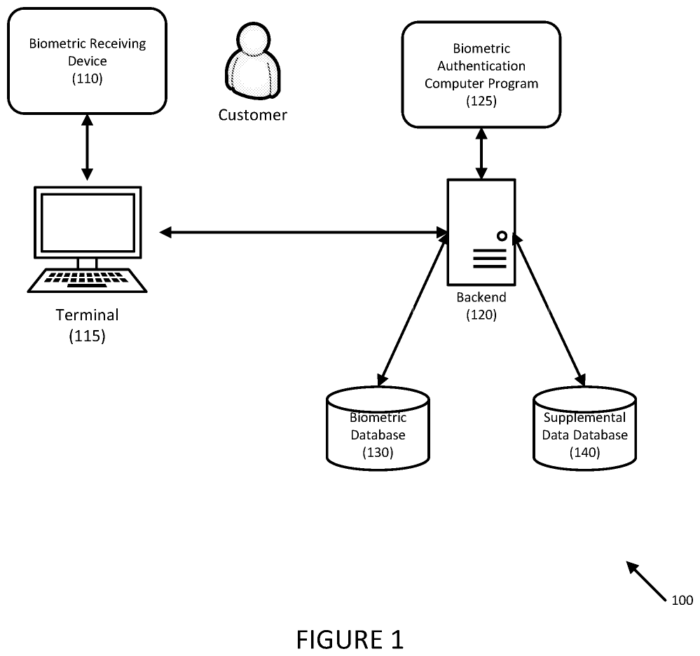

Referring to FIG. 1, a system for scalable biometric authentication is disclosed according to an embodiment. System 100 may include biometric receiving device 110, which may receive a biometric by contact or without contact. Biometric receiving device 110 may communicate with terminal, which may be a point of transaction device, a point-of-sale device, an access device, etc. For example, terminal 115 may be a point-of-sale device for a merchant.

Terminal 115 may communicate with backend 120, which may be any suitable computing device including physical servers, cloud-based servers, combinations, etc. Terminal 115 may execute biometric authentication computer program 125 that may receive a biometric from biometric receiving device 110 and determine whether it matches any stored biometrics in biometric database 130.

Biometric authentication computer program 125 may further access supplemental data database 140 that may contain data that may reduce the amount of stored biometric data in biometric database 130 that the received biometric is compared to. Examples of supplemental data may include fraud data that may be used to determine the most likely customers to be conducting the transaction, location data for customers, spending habits, etc. Instead of the fraud data being used to determine if the transaction is an unexpected transaction for a customer, the fraud data may be inverted or similar in order to identify a subset of all customers that are likely to be conducting the transaction. Further, location data may be used to identify customers that are likely to be in the merchant location. Customer location data may be based on the customers home location, the location of the customers' last credit card use, the location of the customers' last sign-in to an application, etc.). Spending habits may be used to identify the customers that are likely to be conducting the transaction with the merchant.

Two or more of these types of supplemental data may be combined as is necessary and/or desired.

In one embodiment, the customer may be identified using a Bluetooth low energy (BLE) token.

In one embodiment, biometric authentication computer program 125 may further leverage a mathematical function, such as a deep-learning auto-encoding architecture, to map the biometric data to a feature or combination of features, such as biometric markers, in the biometric data that are highly discriminatory. For example, certain features, or combinations of features, may be common to subsets of the biometric data, and may be used to reduce the amount of biometric data to review.

In one embodiment, authentication computer program 125 may generate a numeric multidimensional vector that may represent each biometric. A process that is similar to using “word2vec” to convert a word to a multidimensional vector may be used to create the numeric multidimensional vector for each biometric.

In one embodiment, once a biometric is received, a numeric multidimensional vector may be created, and only stored biometrics having a numeric multidimensional vector within a certain tolerance or numerical range of the received biometric's numeric multidimensional vector may be searched.

In one embodiment, certain features may be used to enable branch and cut searching of the biometric data. For example, one or more certain biometric feature may be used to select a branch, and then another biometric feature may be used to select a subbranch, etc.

In one embodiment, algorithms may be used to identify the subset of customers. Examples of such algorithms include Approximate-Nearest-Neighbors (ANN) methods (e.g., Google's ScaNN, Local Sensitive Hashing, etc.). In embodiments to exact nearest neighbor (the customer in the DB that is the most similar to the presented palm), one or more ANN method may be used as an initial filtering stage to reduce the search space for an exact search, and then conducting the exact search.

This filtering stage may have some statistical guarantees, such as the exact match should be contained in the pre-filtered set with 99.99% probability.

Examples of algorithms include Milvus, Spotify (Annoy), Facebook AI Similarity Search (Faiss), and Scalable Nearest Neighbors (ScaNN). In embodiments, because these algorithms are based on vector similarity searching, encoding may be necessary.

For latency, examples of general quantization and other inference optimization libraries include Onnx Runtime and TensorRT.

For concurrency, the requests may be processed as batches instead of as one image at a time.

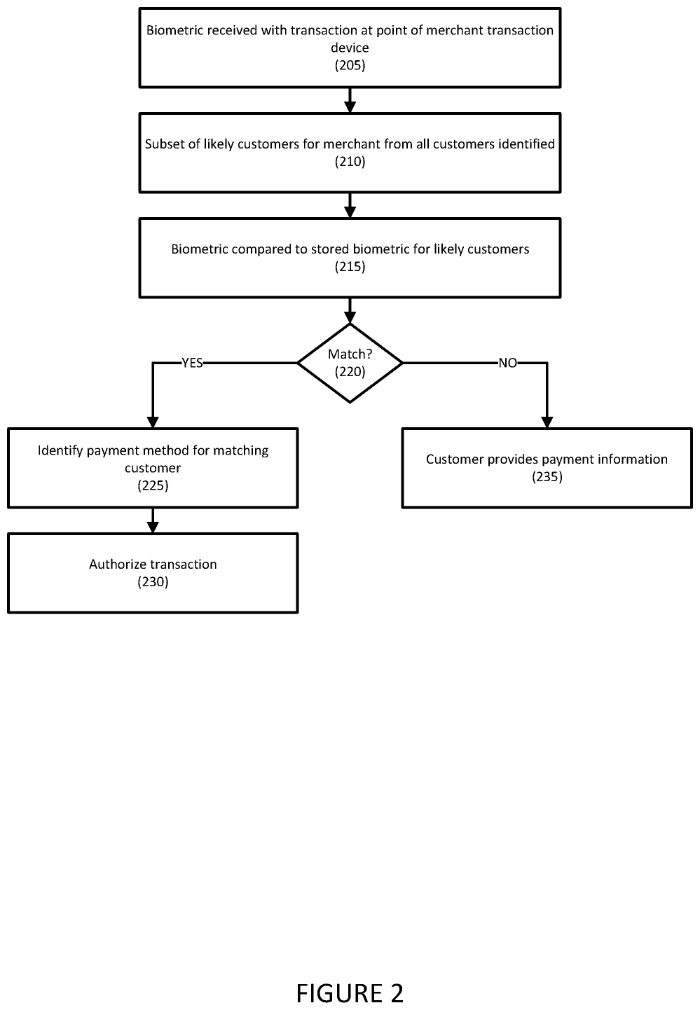

Referring to FIG. 2, a method for scalable biometric authentication is disclosed according to an embodiment.

In step 205, a biometric may be received with a transaction at a merchant point of transaction device. In one embodiment, the transaction may a purchase transaction, and the point of transaction may be a point-of-sale device. The biometric may be any suitable biometric, including palm biometrics (e.g., palm veins), fingerprints, facial biometrics, voice biometrics, eye biometrics, etc.

In step 210, a subset of likely customers for the merchant from all customers may be identified. For example, a biometric authentication computer program may identify a subset of the customers that are most likely to be conducting the transaction. The subset may be identified based on, for example, customer purchase habits, customer purchase history, inverse fraud data, customer and/or merchant location data, etc. Any other suitable data may be used to identify the subset of customers.

For example, the location of the merchant point of transaction device may be used to identify a subset of customers that may reside or work in the area. Customer location data may be received from a database (e.g., home address, work address, etc.), from a customer mobile electronic device (e.g., current location), etc.

In one embodiment, the customer may be identified using RFID using, for example, a BLE tag on the customer's mobile electronic device.

In step 215, the received biometric may be compared to stored biometrics for the subset of likely customers. In one embodiment, instead of searching all stored biometrics for match, the biometric authentication computer program may compare the received biometric to the stored biometrics for the subset of likely customers. This reduces the number of comparisons necessary, thereby reducing computation costs associated with the identification.

In step 220, if there is a match, in step 225, the biometric authentication computer program may retrieve the payment method for the matching customer. For example, the customer may register a payment method with the customer's biometric, and this payment method may be retrieved. In step 230, the transaction may be authorized.

If there is not a match, in step 235, the customer may provide payment information in any suitable manner (e.g., swipe/insert/tap credit card, use of a digital wallet, etc.).

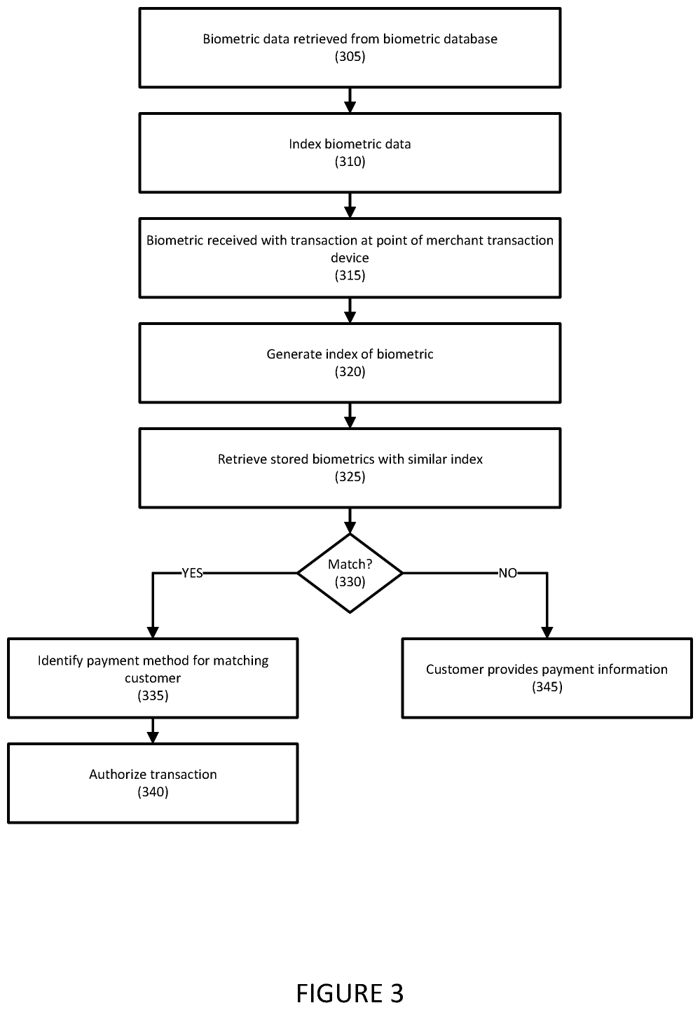

Referring to FIG. 3, a method for scalable biometric authentication is disclosed according to another embodiment.

In step 305, a biometric authentication computer program may retrieve stored biometrics from a biometric database. The biometrics may be any suitable biometric, including palm biometrics (e.g., palm veins), fingerprints, facial biometrics, voice biometrics, eye biometrics, etc.

In step 310, the biometric authentication computer program may process or index the biometric data. For example, the biometric authentication program may auto-encode the biometric data to identify features or combinations of features, such as biometric markers, in the biometric data that are highly discriminatory, such as gender, color, etc. In another embodiment, the biometric authentication program may generate a numeric multidimensional vector for each biometric. In another embodiment, one or more features in the biometric may be selected and a score may be generated for the one or more features. In another embodiment, a hash may be generated for the biometrics, or for a portion of the biometrics.

In step 315, a biometric may be received with a transaction at a point of merchant transaction device, such as a merchant point of sale device.

In step 320, the received biometric may be processed or indexed based on the processing or indexing of the stored biometrics. For example, the received biometric may be indexed, a numeric multidimensional vector may be created for the received biometric, etc.

In step 325, a subset of biometrics may be retrieved. For example, only stored biometrics having a numeric multidimensional vector having a value within a certain tolerance or numerical range of the received biometric's numeric multidimensional vector may be received and searched. As another example, only stored biometrics having the same highly discriminatory features as those in the received biometric may be received and searched. As yet another example, one or more certain biometric feature may be used to select a branch, and then another biometric feature may be used to select a subbranch, etc. until there are no remaining branches.

In step 330, if there is a match, in step 335, the biometric authentication computer program may retrieve the payment method for the matching customer. For example, the customer may register a payment method with the customer's biometric, and this payment method may be retrieved.

In step 340, the transaction may be authorized.

If there is not a match, in step 345, the customer may provide payment information in any suitable manner (e.g., swipe/insert/tap credit card, use of a digital wallet, etc.).

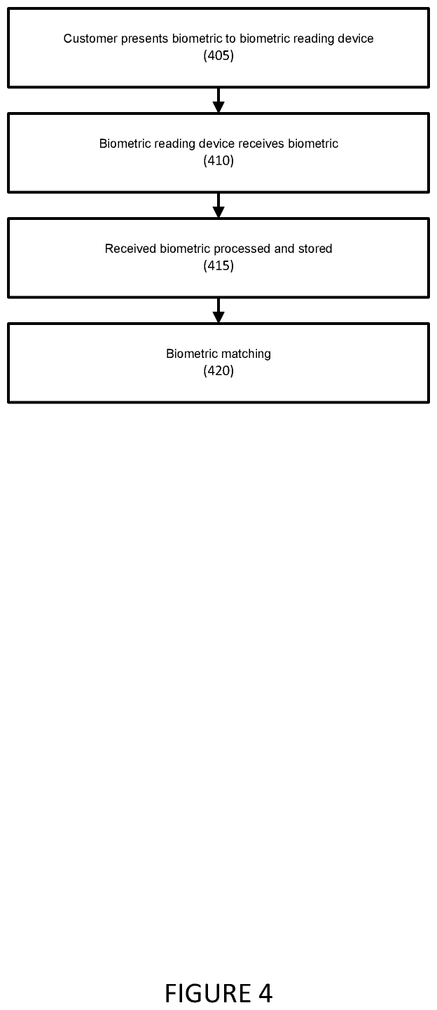

Referring to FIG. 4, a method for biometric registration is disclosed according to one embodiment. As noted above, any suitable biometric may be used, including palm vein scans, fingerprints, facial features, iris scans, etc.

In step 405, a customer may present a biometric to a biometric reading device. In step 410, the biometric reading device may receive the biometric by scanning (e.g., IR scanning), imaging, or any other suitable technology.

In step 415, the received biometric may be processed and stored. In one embodiment, the biometric may be hashed, and only the hash of the biometric may be stored. In one embodiment, the hash may be performed by the biometric reading device.

In one embodiment, during matching (e.g., step 420), a hash of the received biometric may be compared to the stored hashes. In one embodiment, the hash function may be selected to allow for minor differences between the received biometric and the registered biometric so that an exact match is not required.

In another embodiment, the received biometric may be encrypted and stored. For example, the biometric receiving device may encrypt the biometric and send it to storage. The received biometric may remain encrypted in storage. In one embodiment, in step 420, homomorphic encryption may be used to identify a matching stored biometric for a received biometric without decrypting the stored biometric.

In another embodiment, one or more feature vector may be created for the received biometric. For example, a machine learning model that is stored with other stored biometrics. The machine learning model may take an image of the biometric and may convert the image to an embedding, such as a numeric vector that represents the biometric for matching purposes (e.g., in step 420). The numeric vector may include any suitable quantity of numeric elements that is sufficient to distinguish the biometric from other biometrics. An example of 1000 numeric elements; any suitable quantity of numeric elements may be used as is necessary and/or desired.

In one embodiment, the machine learning model may be stored in the biometric scanning device for use in scanning.

During each authentication, the biometric scanning device may convert the biometric into an embedding (e.g., a numeric vector) that represents the biometric for the matching purposes, and the embedding may be encrypted and sent to, for example, the cloud.

During matching (e.g., in step 420), a cloud-based processor may multiply the embedding for the biometric (i.e., a “cosine similarity” operation) with stored embeddings for the other biometrics to generate pair-wise matching scores. The maximum score determines a match for the biometric.

In one embodiment, encryption-related optimization may be used to train the embedding model. For example, homomorphic encrypted addition and multiplication work faster when the inputs have some structure, such as only with integer numbers. Using this structure, the embedding model may be trained to produce embeddings.

In embodiments, as described above, a subset of likely matching biometrics of all stored biometrics may be identified. The subset may be identified based on location, inverse fraud data, transaction likelihood, spending habits, etc. Thus, instead of performing hash matching, homomorphic encryption matching, and/or a cosine similarity operation for all stored biometrics, some or all of these functions may be instead performed on the subset.

In one embodiment, the homomorphic encryption may leverage private keys from multiple parties and may provide multi-party encryption. For example, embodiments may provide multiple points of connectivity to different parties of devices, such as a biometric reading device, a merchant/point of sale device, networks, etc. Each party or device may have access to certain data, and may be able to compute on a subset of the data. This may be performed in parallel.

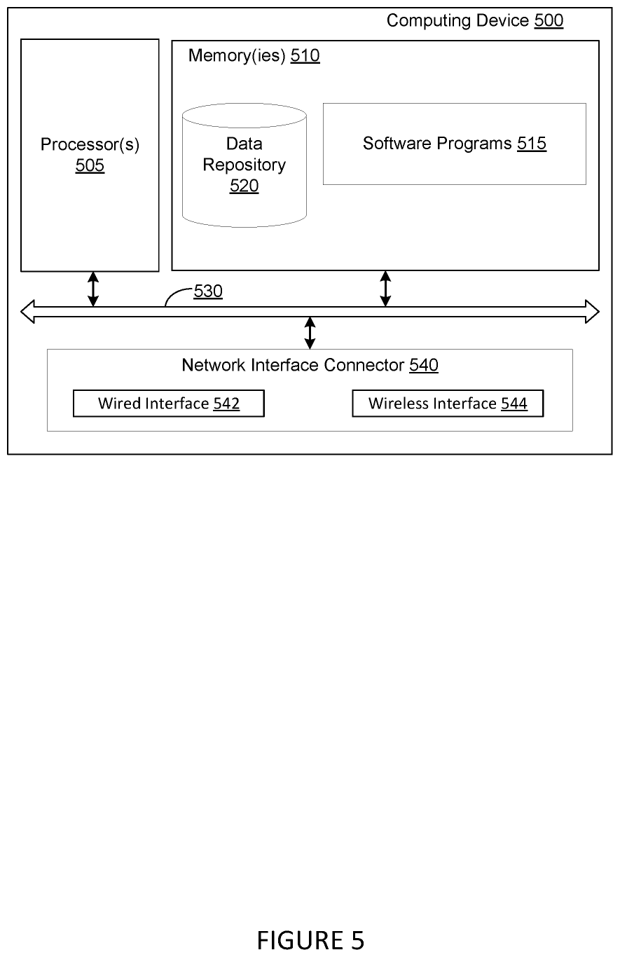

FIG. 5 depicts an exemplary computing system for implementing aspects of the present disclosure. FIG. 5 depicts exemplary computing device 500. Computing device 500 may represent the system components described herein. Computing device 500 may include processor 505 that may be coupled to memory 510. Memory 510 may include volatile memory. Processor 505 may execute computer-executable program code stored in memory 510, such as software programs 515. Software programs 515 may include one or more of the logical steps disclosed herein as a programmatic instruction, which may be executed by processor 505. Memory 510 may also include data repository 520, which may be nonvolatile memory for data persistence. Processor 505 and memory 510 may be coupled by bus 530. Bus 530 may also be coupled to one or more network interface connectors 540, such as wired network interface 542 or wireless network interface 544. Computing device 500 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for scalable biometric authentication, comprising:
receiving, by a biometric authentication computer program executed by a computer processor, a transaction request for a transaction comprising a received biometric;
identifying, by the biometric authentication computer program, a subset of likely customers from a set of customers for the transaction;
retrieving, by the biometric authentication computer program, stored biometrics for the subset of customers;
identifying, by the biometric authentication computer program, one of the stored biometrics for the subset of customers that matches the received biometric; and
retrieving, by the biometric authentication computer program, a stored payment method for the identified stored biometric.

2. The method of claim 1, wherein the received biometric and the stored biometrics comprise a palm biometric, a fingerprint biometric, a facial biometric, a voice biometric, and/or an eye biometric.

3. The method of claim 1, wherein the subset of customers is identified based on a customer location and a merchant location.

4. The method of claim 1, wherein the subset of customers is identified based on customer purchase history.

5. The method of claim 1, further comprising:
authorizing, by the biometric authentication computer program, the transaction.

6. A method for scalable biometric authentication, comprising:
retrieving, by a biometric authentication computer program executed by a computer processor, a plurality of stored biometrics from a biometric database;
generating, by the biometric authentication computer program, an index for each the plurality of stored biometrics;
receiving, by the biometric authentication computer program, a transaction request comprising a received biometric;
generating, by the biometric authentication computer program, an index for the received biometric;
retrieving, by the biometric authentication computer program, a subset of the plurality of stored biometrics based on the index of the received biometric and the indices of the plurality of stored biometrics;
identifying, by the biometric authentication computer program, one of the plurality of stored biometrics in the subset that matches the received biometric; and
retrieving, by the biometric authentication computer program, a stored payment method for the identified stored biometric.

7. The method of claim 6, wherein the received biometric and the stored biometrics comprise a palm biometric, a fingerprint biometric, a facial biometric, a voice biometric, and/or an eye biometric.

8. The method of claim 6, wherein the index for each of the plurality of stored biometrics is generated by auto-encoding the stored biometric, and the index of the received biometric is generated by auto-encoding the stored biometric.

9. The method of claim 6, wherein the index for each of the plurality of stored biometrics comprises a numeric multidimensional vector, and the index of the received biometric comprises a numeric multidimensional vector.

10. The method of claim 6, wherein the index for each the plurality of stored biometrics comprises a score for a feature in each biometric, and the index of the received biometric comprises a score for the feature in the received biometric.

11. The method of claim 6, wherein the index for each of the plurality of stored biometrics comprises a hash of the stored biometric, and the index of the received biometric comprises a hash of the received biometric.

12. A method for biometric registration, comprising:
receiving, by a biometric authentication computer program executed by a computer processor and from a biometric reading device, a biometric from a user;
hashing, by the biometric authentication computer program and using a hash function, the biometric;
comparing, by the biometric authentication computer program, the hashed biometric to a plurality of stored biometric hashes for registered biometrics in a biometric hash database, wherein the plurality of stored biometric hashes are generated using the hash function;
determining, by the biometric authentication computer program, that the hashed biometric does not match any of the stored biometric hashes; and
storing, by the biometric authentication computer program, the biometric in a biometric database.

13. The method of claim 12, wherein the biometric comprises a palm biometric, a fingerprint biometric, a facial biometric, a voice biometric, and/or an eye biometric.

14. The method of claim 12, further comprising:
encrypting, by the biometric authentication computer program, the biometric before storing the biometric in the biometric database.
